(19) United States
(12) Patent Application Publication
(10) Pub. No.: US 2004/0030539 A1
(43) Pub. Date: Feb. 12, 2004

(54) System and method for extracting, distributing and backing up audio CD information over a network

(75) Inventors: Larry Tsai, Taipei (TW); Jesse He, Chongqing City (CN)

Correspondence Address: HOGAN & HARTSON L.L.P., 500 S. GRAND AVENUE, SUITE 1900, LOS ANGELES, CA, 90071-2611, US

(73) Assignee: FARSTONE TECH. INC.

(21) Appl. No.: 10/313,095

(22) Filed: Dec. 5, 2002

(30) Foreign Application Priority Data
Aug. 9, 2002 (TW) 091118055

(51) Int. Cl. G06F 9/455

(52) U.S. Cl. 703/21; 700/94

(57) ABSTRACT

A network multimedia system comprises a selecting means, a generating means, a processing means and a playback means. The selecting means is used for selecting audio data contained in a CD. The generating means is used for generating an image file having at least one audio track by compressing the audio data, the audio track corresponding to the audio data. The processing means is used for converting the image file into the CD, and for transmitting a playback signal. The playback means is used for receiving the playback signal to playback the CD. The network multimedia system in the invention can playback the emulated CD in a digital manner, so as to directly playback the VCD image file with CD playback software.

### BACKGROUND OF THE INVENTION

1. Field of the Invention

The present invention relates generally to an emulating technique for distributing Audio CD data, and more particularly to a system and method for creating a single image file that can be simultaneously accessed over a network.

2. Description of Prior Art

A plurality of CD audio entries, called CD tracks, is contained in an audio CD. Conventional storage of audio CD data ordinarily creates several backed-up files in a computer system. Every backed-up file corresponds to every CD track. Such backed-up files are stored in a hard disk of the computer system. Generally, it's difficult for the users to attempt to keep all of the backed-up files. The reason is that some of the backed-up files may be damaged during operations of the computer system. If so, the backed-up audio CD data can no longer be played back normally. It would be very inconvenient to the users.

For example, the conventional CD emulator, such as the Virtual CD software developed by Micro Test Corporation, backs up CD data to several files stored in the hard disk. Referring to FIG. 1, a schematic block diagram of the Virtual CD software is shown. The user inserts a CD 11 into a CD-Rom drive 1. The Virtual CD 2 includes a generating module 21 and a user interface 22. The generating module 21 backs up data stored in the CD 11 to an .FCD extension file 31a and several .WAV extension audio files 311-31n created under a directory 31 of the hard disk 3.

The .WAV extension audio files generally takes up storage space of more than ten Megabytes per minute. Accordingly to the conventional Virtual CD software, backing up CDs would take up a large amount of storage space in the hard disk of the computer system.

Referring to FIG. 2, a schematic flow chart of the Virtual CD software is shown.

The Virtual CD software backs up CD data to several files. First, in step S11, the generating module 21 detects whether a CD is inserted into a CD-Rom drive. Then, in step S12, the user selects audio tracks via the user interface 22. Next, in step S13, the generating module 21 creates a file directory 31. Finally, in step S14, the generating module 21 creates an .FCD extension file 31a and several .WAV extension audio files 311-31n under the file directory 31.

The generating module 21 includes a mounting program to mount such .FCD extension file 31a, in order to play back the CD audio entries via a CD player. The .FCD extension file 31a records information regarding title of all .WAV extension audio files 311-31n. When playing back the CD audio entries, the corresponding .WAV extension audio files are needed to be accessed. In the case any backed-up file is lost by accident or title of the backed-up file is renamed, the CD player cannot playback such CD audio entry thereby.

Referring to FIG. 3, a schematic block diagram of the Windows Media Player software is shown. The Windows Media Player software is developed by Microsoft Corporation, backs up CD data to several files stored in the hard disk. The user inserts a CD 41 into a CD-Rom drive 4. The Windows Media Player 5 includes a generating module 51 and a user interface 52. The generating module 51 backs up data stored in the CD 41 to several .WMA extension audio files 611-61n created under a directory 61 of the hard disk 6. The .WMA extension indicates a file format and how the content is encoded.

Referring to FIG. 4, a schematic flow chart of the Windows Media Player software is shown. The Windows Media Player software backs up CD data to several files. First, in step S41, the generating module 51 detects whether a CD is inserted into a CD-Rom drive. Then, in step S42, the user selects audio tracks via the user interface 52. Next, in step S43, the generating module 51 creates a file directory 61. Finally, in step S44, the generating module 51 creates several .WMA extension audio files 611-61n under the file directory 61.

When playing back the CD audio entries via Windows Media Player or compatible Player, the corresponding .WMA extension audio files are needed to be accessed. In the case any backed-up file is lost by accident, the CD player cannot playback such CD audio entry thereby.

The Fantom CD software developed by An Chen Computer Corporation backs up CD data to two files stored in the hard disk. An .MDS extension file is to store index of CD audio entries and information regarding backed-up files, and an .MDF extension file is to store all audio entries. The Fantom CD software is incapable of selecting audio entries and Codec. All audio entries contained in the CD will be backed up. Moreover, the user cannot compress such backed-up files by using MP3. Accordingly, the backed-up files occupy a large amount of storage space in the hard disk.

### SUMMARY OF THE INVENTION

The present invention provides an emulating system and method to resolve the foregoing problems faced by the conventional CD emulator. The present invention also has the advantage of economizing the occupied storage space by backed-up file.

An object of the present invention is to provide an emulating system and method, wherein a single backed-up file can be created for convenient access and distribution.

Another object of the present invention is to provide an emulating system and method, which can select CD tracks to be backed up.

A further object of the present invention is to provide an emulating system and method, which can economize the storage space by a wide margin. In accordance with an aspect of the present invention, a network multimedia system is used for emulating a CD in a computer system. The network multimedia system includes a selecting means, a generating means, a processing means and a playback means. The selecting means is used for selecting audio data contained in the CD.

The generating means is used for generating an image file having at least one audio track by compressing the audio data, the audio track corresponding to the audio data. The processing means is used for converting the image file into the CD, and for transmitting a playback signal. The playback means is used for receiving the playback signal to playback the CD.

In the preferred embodiment of the invention, the network multimedia system further comprises a converter to compress the audio data, the converter is selected from the group consisting of MP3, WMA, and PCM. The CD is selected from the group consisting of audio CD, mixed mode CD, and CD Extra. The image file is a single image file. The image file includes at least one image file, each image file has a file head, and the file head keeps a track list, a decoding parameter and attributes of the CD. The processing means includes a mounting module for mounting the image file, the generating means includes an analyzing module and an I/O module, the analyzing module analyzes information of the CD, and the I/O module can store encode information in the image file. The playback means is a playback software suitable for digital playback.

In accordance with another aspect of the present invention, a CD emulation system is suitable for a computer system to emulate CD and create an image file. The CD emulation system comprises a selecting means, a generating means and a processing means. The selecting means is used for selecting audio data contained in a CD. The generating means is used for generating an image file having at least one audio track by compressing the audio data, the audio track corresponding to the audio data. The processing means is used for converting the image file into the CD, and for transmitting a playback signal.

In the preferred embodiment of the invention, the network multimedia system further comprises a converter to compress the audio data, the converter is selected from the group consisting of MP3, WMA, and PCM. The CD is selected from the group consisting of audio CD, mixed mode CD, and CD Extra. The image file is a single image file. The image file includes at least one image file, each image file has a file head, and the file head keeps a track list, a decoding parameter and attributes of the CD. The processing means includes a mounting module for mounting the image file. The generating means includes an analyzing module and an I/O module, the analyzing module analyzes information of the CD, and the I/O module can store encode information in the image file.

In accordance with a further aspect of the present invention, another CD emulation system is suitable for a computer system. The CD emulation system comprises a selecting means, a generating means and a processing means. The selecting means is used for selecting audio data contained in a CD. The generating means is used for generating an image file having at least one audio track corresponding to the audio data. The processing means is used for converting the image file into the CD, and for transmitting a playback signal.

In the preferred embodiment of the invention, the network multimedia system further comprises a converter to compress the audio data, the converter is selected from the group consisting of MP3, WMA, and PCM. The CD is selected from the group consisting of audio CD, mixed mode CD, and CD Extra. The image file is a single image file. The image file includes at least one image file, each image file has a file head, and the file head keeps a track list, a decoding parameter and attributes of the CD. The processing means includes a mounting module for mounting the image file, the generating means includes an analyzing module and an I/O module, the analyzing module analyzes information of the CD, and the I/O module can store encode information in the image file.

The present invention may best be understood through the following description with reference to the accompanying drawings, in which:

### BRIEF DESCRIPTION OF THE DRAWING

FIG. 1 is a schematic block diagram of the Virtual CD software.

FIG. 2 is a schematic flow chart of the Virtual CD software.

FIG. 3 is a schematic block diagram of the Windows Media Player software.

FIG. 4 is a schematic flow chart of the Windows Media Player software.

FIG. 5 is a schematic block diagram of a CD emulation system of a preferred embodiment according to the present invention.

FIG. 6 is a schematic flow chart of the CD emulation system of a preferred embodiment according to the present invention.

FIG. 7 is a schematic block diagram of a network multimedia system of a preferred embodiment according to the present invention.

FIG. 8 is a schematic block diagram of a network multimedia system of another preferred embodiment according to the present invention.

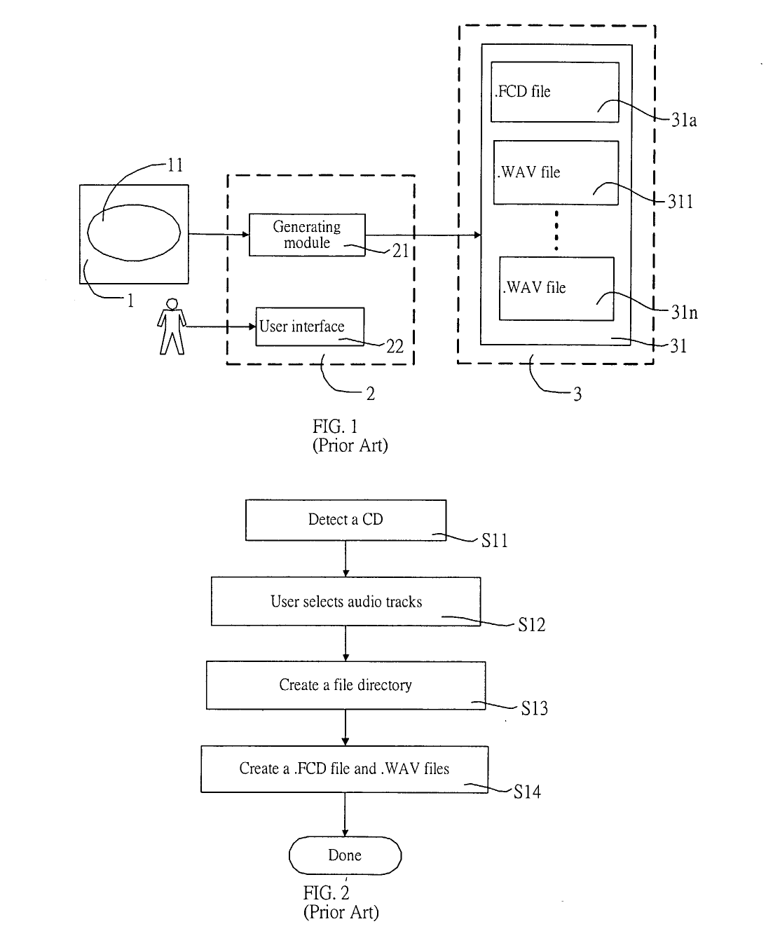

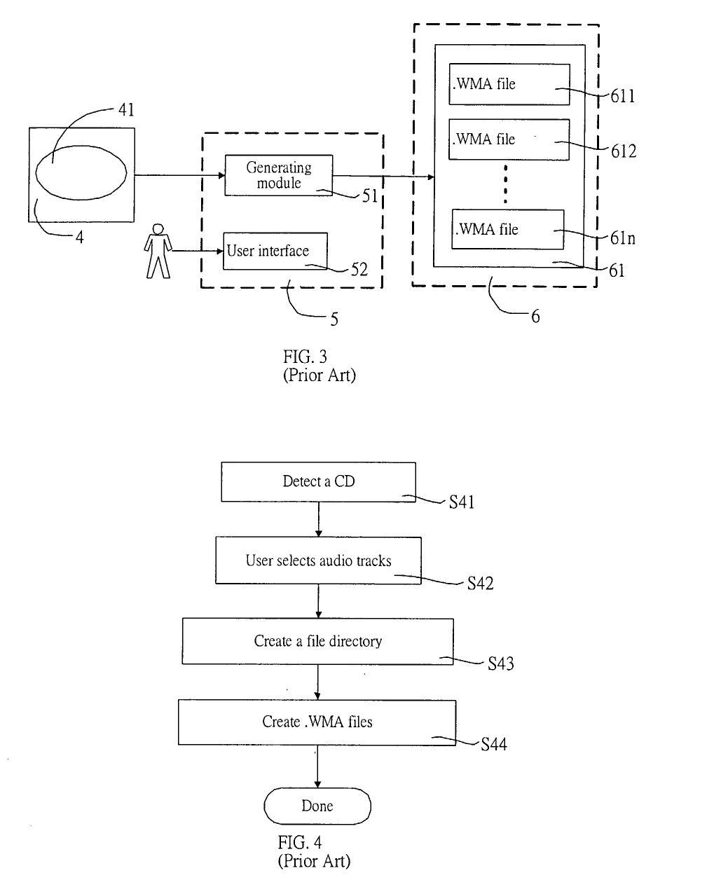

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

The present invention describes an emulating system and method, which can select CD tracks to be backed up, and then a single backed-up file can be created for convenient access and distribution. Hence, the storage space can he economized by a wide margin. Therefore, the drawbacks faced by the conventional CD emulating program can be solved completely.

According to the preferred embodiment of the present invention, a CD emulation system is suitable for a computer system to emulate a CD and create an image file. The CD emulation system comprises a selecting means, a generating means and a processing means. The selecting means is used for selecting audio data contained in a CD. The generating means is used for generating an image file having at least one audio track by compressing the audio data, the audio track corresponding to the audio data. The processing means is used for converting the image file into the CD, and for transmitting a playback signal.

The CD emulation system further comprises a converter to compress the audio data, the converter is selected from the group consisting of MP3, WMA, and PCM. The CD is selected from the group consisting of audio CD, mixed mode CD, and CD Extra. The image file is a single image file. The image file includes at least one image file, each image file has a file head, and the file head keeps a track list, a decoding parameter and attributes of the CD. The processing means includes a mounting module for mounting the image file. The generating means includes an analyzing module and an I/O module, the analyzing module analyzes information of the CD, and the I/O module can store encode information in the image file.

According to the preferred embodiment of the present invention, there is another CD emulation system suitable for a computer system. The CD emulation system comprises a selecting means, a generating means and a processing means. The selecting means is used for selecting audio data contained in a CD. The generating means is used for generating an image file having at least one audio track corresponding to the audio data. The processing means is used for converting the image file into the CD, and for transmitting a playback signal. Another CD emulation system further comprises a converter to compress the audio data, the converter is selected from the group consisting of MP3, WMA, and PCM. The CD is selected from the group consisting of audio CD, mixed mode CD, and CD Extra. The image file is a single image file. The image file includes at least one image file, each image file has a file head, and the file head keeps a track list, a decoding parameter and attributes of the CD. The processing means includes a mounting module for mounting the image file, the generating means includes an analyzing module and an I/O module, the analyzing module analyzes information of the CD, and the I/O module can store encode information in the image file.

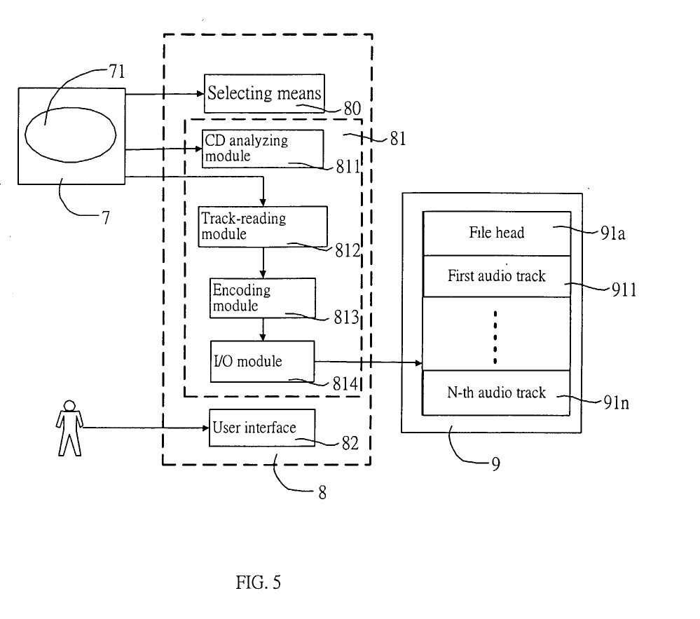

Referring to FIG. 5, a schematic block diagram of a CD emulation system of a preferred embodiment according to the present invention is shown. The user inserts a CD 71 into a CD-Rom drive 7. The CD emulation system 8 according to the present invention includes a selecting means 80, a generating means 81 and a user interface 82. The generating means 81 comprises a CD analyzing module 811, a track-reading module 812, an encoding module 813 and an I/O module 814. The hard disk 9 of the computer system has a CD image file 91 created by backing up the CD 71.

The CD analyzing module 811 is used for detecting and analyzing information of the CD 71, such as audio tracks, parameter and attributes of the CD 71. The user interface 82 guides the user to create the image file 91. The selecting means 80 selects audio tracks of the CD 71 to be backed up for creating the image file 91. The track-reading module 812 reads the audio tracks of the CD 71 according to the audio tracks selected by the selecting means 80. The encoding module 813 encodes the read audio tracks. The encoding module 813 can invoke any audio Codec, such as PCM (Pulse Code Modulation) Codec, MP3(MPEG Layer-3) Codec, or WMA (Window Media Audio) Codec, to encode audio data. The I/O module 814 creates the image file 91 in the hard disk 9.

The image file 91 contains a file head 91a and audio tracks 911-91n. The file head 91a keeps information, such as a track list, a decoding parameter and attributes of the CD. In addition, the begin position and the finish position can be stored to the file head 91a of the image file.

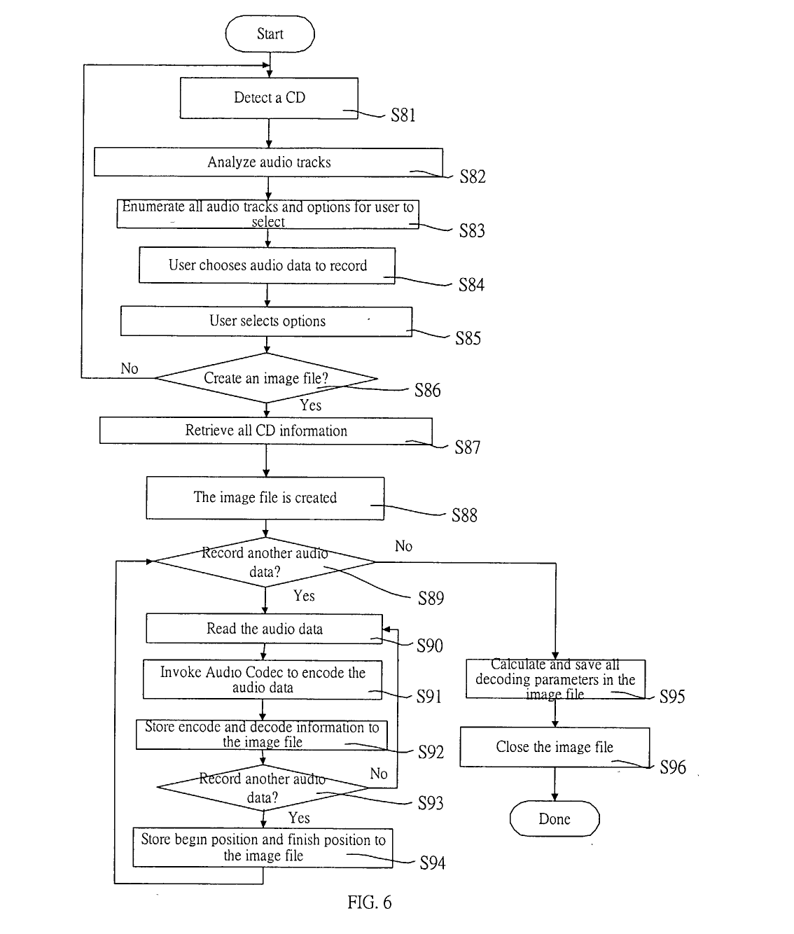

Referring to FIG. 6, a schematic flow chart of the CD emulation system of a preferred embodiment according to the present invention is shown. First, in step S81, the CD analyzing module 811 detects whether a CD is inserted into a CD-Rom drive. Then, in step S82, the CD analyzing module 811 reads and analyzes information of the CD 71, such as Table of Contents information, audio tracks, parameter and attributes of the CD 71. Next, in step S83, the user interface 82 enumerates all audio tracks and options for the user to select and to store in an image file 91. Then, in step S84, the user chooses audio track data to record to the image file 91 via the selecting means 80. Next, in step S85, the user selects the options through the user interface 82. Such options may include windows sound format for an image file. Then, in step S86, the user confirms whether to create an image file. If the user wants to create an image file, then the CD analyzing module 811 retrieves all necessary CD information including the parameter and the attributes of the CD 71 from the CD. Next, in step S88, the I/O module 814 creates the image file 91. According to the user's choice, a track list is prepared for later extracting all audio tracks from the audio CD.

Then, in step S89, determine whether there is another audio data to be recorded. If there are another audio track, then, in step S90, the track-reading module 812 reads such audio track of the CD 71. Next, in step S91, the encoding module 813 invokes audio Codec to encode the retrieved audio data. Then, in step S92, the I/O module 814 stores encode and decode information to the image file 91. Next, in step S93, determine whether there is any audio data not to be recorded yet. Then, in step S94, the I/O module 814 stores the begin position and the finish position to the file head 91a of the track list. In step S95, the I/O module 814 calculates and saves all decoding parameters in the image file 91. Finally, in step S96, the I/O module 814 closes the image file 91. The generating operation is completed, and a single image file is created.

According to the preferred embodiment of the present invention, a network multimedia system is used for accessing an emulated CD in a computer system. The network multimedia system includes a selecting means, a generating means, a processing means and a playback means. The selecting means is used for selecting audio data contained in the CD. The generating means is used for generating an image file having at least one audio track by compressing the audio data, the audio track corresponding to the audio data. The processing means is used for converting the image file into the CD, and for transmitting a playback signal. The playback means is used for receiving the playback signal to playback the CD.

The network multimedia system further comprises a converter to compress the audio data, the converter is selected from the group consisting of MP3, WMA, and PCM. The CD is selected from the group consisting of audio CD, mixed mode CD, and CD Extra. The image file is a single image file. The image file includes at least one image file, each image file has a file head, and the file head keeps a track list, a decoding parameter and attributes of the CD. The processing means includes a mounting module for mounting the image file, the generating means includes an analyzing module and an I/O module, the analyzing module analyzes information of the CD, and the I/O module can store encode information in the image file. The playback means is a playback software suitable for digital playback.

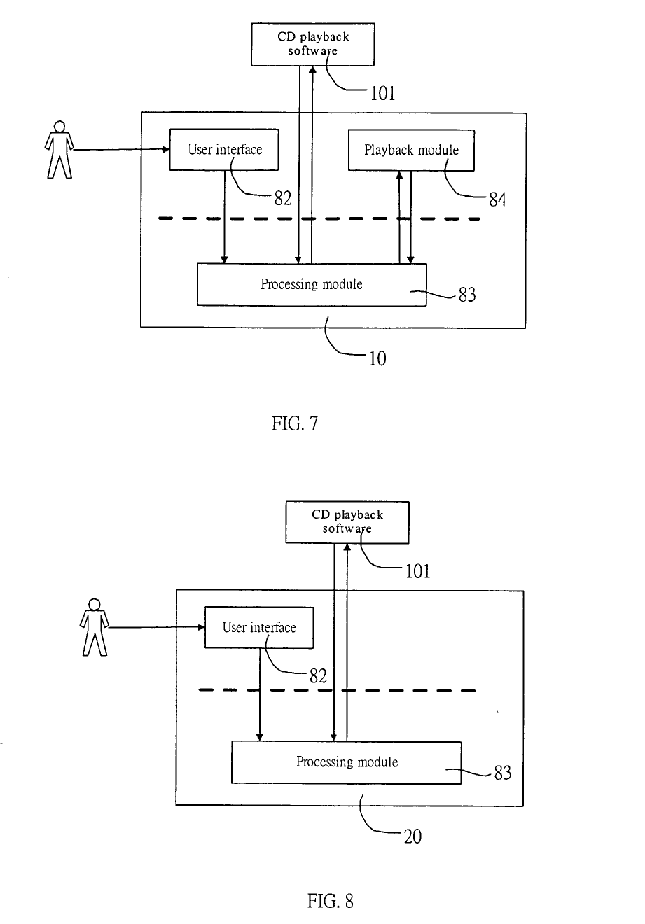

Referring to FIG. 7, a schematic block diagram of a network multimedia system having an analog playback means of a preferred embodiment according to the present invention is shown. The network multimedia system 10 according to the present invention further includes a processing module 83 and a playback means. The playback means comprises a playback module 84 and a CD playback software 101.

The image file 91 must be mounted before it can be accessed. The processing module 83 mounts the image file 91 into the CD emulation system 8 to emulate a CD data according to the path of the image file 91. The CD playback software 101 issues playback request to the processing module 83. The processing module 83 enables the playback module 84 to playback the requested tracks. The playback module 84 retrieves the position of the requested tracks at the image file 91, so as to playback such tracks. The processing module 83 obtains the position of the actual CD, corresponding the position of the played data at the image file 91. The CD playback software 101 receives the current position of the played data at the image file 91 from the processing module 83.

FIG. 8 is a schematic block diagram of a network multimedia system having a digital playback software of a preferred embodiment according to the present invention. The network multimedia system 20 according to the present invention further includes a processing module 83 and a CD playback software 101.

The image file 91 must be mounted before it can be accessed. The processing module 83 mounts the image file 91 into the CD emulation system 8 to emulate a CD data according to the path of the image file 91. The CD playback software 101 issues playback request to the processing module 83. The processing module 83 transmits data information regarding the requested tracks of the emulated CD to the CD playback software 101.

The network multimedia system of the present invention does not need to mount all audio tracks to the computer memory, so that the system resources can be more effectively economized. Also, the network multimedia system in the invention can playback the emulated CD in a digital manner, so as to directly playback the VCD image file with CD playback software.

The CD emulation system of the present invention accepts users' choices with respect to the created tracks according to their preferences. Even though the user selects thousands of audio tracks, the CD emulation system only backed the corresponding data up to a single image file. In contrast, the conventional software has to create thousands of backed-up files under the same condition. Therefore, the drawbacks faced by the prior arts can be solved.

The present invention can economize the occupied storage space greatly, since the present invention has the advantage of compressing the backed-up image file by using MP3, thereby preventing the occupation of the hard disk. The conventional problems faced by the conventional emulating techniques can be effectively solved.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A network multimedia system comprising:
a selecting means for selecting audio data contained in a CD;
a generating means for generating an image file having at least one audio track by compressing said audio data, said audio track corresponding to said audio data;
a processing means for converting said image file into said CD, and for transmitting a playback signal; and
a playback means for receiving said playback signal to playback said CD.

2. The network multimedia system according to claim 1, wherein said CD is selected from the group consisting of audio CD, mixed mode CD, and CD Extra.

3. The network multimedia system according to claim 1, wherein said image file is a single image file.

4. The network multimedia system according to claim 1, wherein said image file includes at least one image file, each image file has a file head, and said file head keeps a track list, a decoding parameter and attributes of said CD.

5. The network multimedia system according to claim 1, wherein said processing means includes a mounting module for mounting said image file, said generating means includes an analyzing module and an I/O module, said analyzing module analyzes information of said CD, and said I/O module can store encode information in said image file.

6. The network multimedia system according to claim 1, wherein said playback means is a playback software suitable for digital playback.

7. The network multimedia system according to claim 1, further comprising a converter to compress said audio data, said converter is selected from the group consisting of MP3, WMA, and PCM.

8. A CD emulation system comprising:
a selecting means for selecting audio data contained in a CD;
a generating means for generating an image file having at least one audio track by compressing said audio data, said audio track corresponding to said audio data; and
a processing means for converting said image file into said CD, and for transmitting a playback signal.

9. The CD emulation system according to claim 8, wherein said CD is selected from the group consisting of audio CD, mixed mode CD, and CD Extra.

10. The CD emulation system according to claim 8, wherein said image file is a single image file.

11. The CD emulation system according to claim 8, wherein said image file includes at least one image file, each image file has a file head, and said file head keeps a track list, a decoding parameter and attributes of said CD.

12. The CD emulation system according to claim 8, wherein said processing means includes a mounting module for mounting said image file.

13. The CD emulation system according to claim 8, wherein said generating means includes an analyzing module and an I/O module, said analyzing module analyzes information of said CD, and said I/O module can store encode information in said image file.

14. The CD emulation system according to claim 8, further comprising a converter to compress said audio data, said converter is selected from the group consisting of MP3, WMA, and PCM.

15. A CD emulation system comprising:
a selecting means for selecting audio data contained in a CD;
a generating means for generating an image file having at least one audio track corresponding to the audio data; and
a processing means for converting the image file into the CD, and for transmitting a playback signal.

16. The CD emulation system according to claim 15, wherein said CD is selected from the group consisting of audio CD, mixed mode CD, and CD Extra.

17. The CD emulation system according to claim 15, wherein said image file is a single image file.

18. The CD emulation system according to claim 15, wherein said image file includes at least one image file, each image file has a file head, said file head keeps a track list, a decoding parameter and attributes of said CD.

19. The CD emulation system according to claim 15, wherein said processing means includes a mounting module for mounting said image file, said generating means includes an analyzing module and an I/O module, said analyzing module analyzes information of said CD, and said I/O module can store encode information in said image file.

20. The CD emulation system according to claim 15, further comprising a converter to compress said audio data, said converter is selected from the group consisting of MP3, WMA, and PCM.
